(19) United States
(12) Patent Application Publication
(10) Pub. No.: US 2005/0278081 A1
(43) Pub. Date: Dec. 15, 2005

(54) Expandable control unit

(75) Inventors: Werner Mayer, Fellbach (DE); Hans-Joerg Strud, Altbach (DE); Stefan Weber, Wolfschlugen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/123,099

(22) Filed: May 6, 2005

(30) Foreign Application Priority Data
May 7, 2004 (DE) 10 2004 022 614.8

(51) Int. Cl. G06F 7/00

(52) U.S. Cl. 701/1

(57) ABSTRACT

An expandable control unit for controlling components in a vehicle, having a microcomputer, a main memory means and input/output interfaces for connecting external sensors and/or actuators. An internal data bus is provided for addressing the data, and an external vehicle data bus is provided for networking with other control units. A circuit is provided for expansion of the data processing capacity of the microcomputer. The control unit has an interface by which the circuit can be connected to the address data bus and the internal data bus. The circuit is encapsulated within a housing with a voltage supply, level converter, expansion memory, sensor/actuator interface and logic processing unit. The level converter adjusts the voltage level of the signals and/or data of the microcomputer to the voltage level of the circuit and the logic processing unit processes data of the main memory unit, so that sensors and/or actuators can be connected directly to the circuit via the sensor/actuator interface.

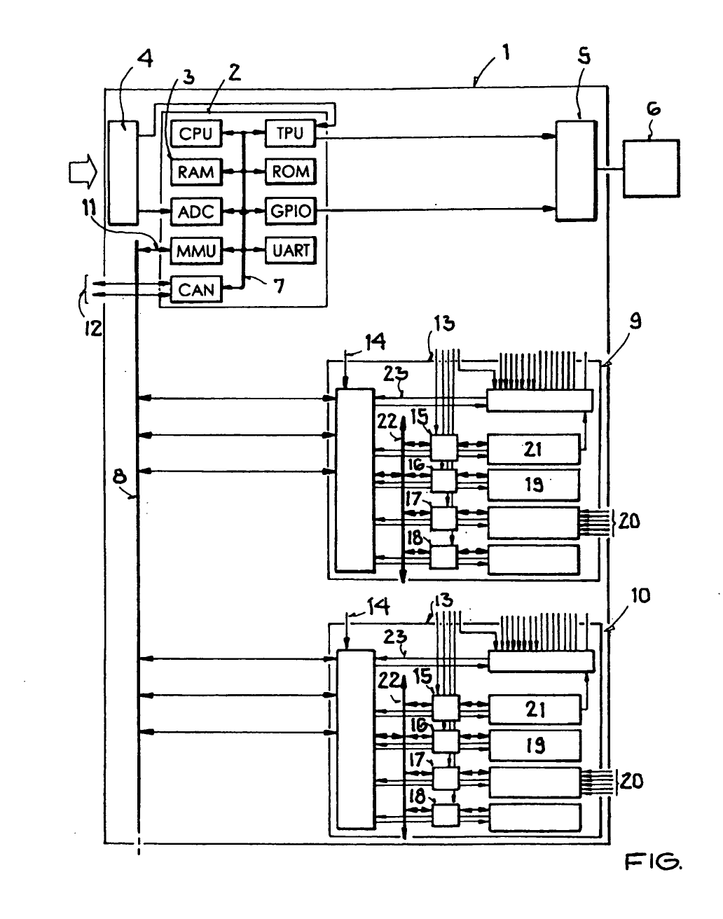

### BACKGROUND AND SUMMARY OF THE INVENTION

This application claims the priority of German patent application 102004022614.8, filed May 7, 2004, the disclosure of which is expressly incorporated by reference herein.

This invention relates to an expandable control unit for controlling components in a vehicle having a microcomputer, a main memory unit and an input/output interface for connecting external sensors and/or actuators. An internal data bus is provided for addressing data. To expand the data processing capacity of the microcomputer, a circuit (e.g., a memory expansion) is connectable to the control unit.

Control units are used today in vehicles for controlling, for example, an internal combustion engine. The control units have a microcomputer; for example, a microcontroller with integrated program memory and data memory (RAM, ROM) as the main data memory. An AD converter, input and output interfaces, timer units and data bus interfaces are required for controlling sensors and actuators. Such microcomputers are adapted to the particular internal combustion engine with regard to their efficiency, program memory size and input/output functionality, e.g., the number of input/output ports, the AD converter channels, the timer channels or serial interfaces. Since internal combustion engines with a larger number of cylinders (e.g., 8 or 12) require greater computation power than smaller engines but are manufactured in smaller numbers, most control units are designed for internal combustion engines with 4- or 6-cylinder motors. Control units in internal combustion engines with a greater number of cylinders therefore rapidly reach their data processing limit.

Furthermore, new combustion concepts (e.g., direct fuel injection, compressor charging, exhaust aftertreatment or hybrid drive) require additional control and regulating functions in the control unit for an international combustion engine, but these functions exceed the data processing limit of the microcomputer in the control unit. One way to accommodate the data processing load is to shift certain computation tasks to another control unit. Because of the interposed data bus operation, however, this regularly leads to interference in realtime operation, so that other solutions to this problem are needed.

German patent document DE 197 50 662 C2 describes a vehicle control unit having a first microcomputer for performing control functions and a communications coprocessor for converting the data formats of a first data bus to the data formats of a second data bus. The communication coprocessor ensures processing of the computation-intensive gateway functionality, without burdening the microcomputer itself with these communication tasks. Consequently, the microcomputer may be used exclusively for the control functions in the transportation means. However, this arrangement makes no provision for a subsequent expansion of the control unit. Instead the control unit is designed for the maximum data processing task, and operates with a low utilization of capacity in processing less computation-intensive tasks.

German patent document DE 197 14 963 A1 describes a control unit for an internal combustion engine, in which a digital logic circuit connected externally to the control unit receives the crankshaft and camshaft pulse train of the internal combustion engine. The microcomputer of the control unit determines which pulse train is to be used as the reference for fuel injection. At the output, a sensor is connected directly to the external logic circuit. The logic circuit supplies sensor signals to the control unit and performs data preprocessing. However, the digital logic circuit cannot be connected to the control unit via the internal data bus so that it is possible to directly access the main memory data in realtime. No level converters for adapting the voltage level of the data of the microcomputer to the voltage level of the external circuit are disclosed there.

German patent document DE 101 60 476 A1 describes a control unit, which is incorporated via a data bus to other control units in a vehicle. The control unit contains a second microcomputer as a means for calculating control data. An interface is provided between the two microcomputers of the control unit for acquiring the duration of the control processes, with the time-determining means generating a limit value control signal whenever the actual value exceeds a maximum limit value, or falls below a minimum, so that a realtime control function can be implemented by one of the microcomputers.

German patent document DE 101 39 610 A1 discloses a universal computer architecture for a vehicle having a microprocessor for processing control programs. The computer has reconfigurable hardware, which in the installed state of the computer allows subsequent reconfiguration of peripheral components or an interface. An algorithm for reconfiguration of the hardware is downloaded onto the control unit via a hardware description language, thereby reconfiguring the hardware accordingly.

International patent document WO 03/065453 A1 discloses a pickup device for a programmable electronic processing apparatus, which is divided into at least a first and a second function unit, representing in particular monolithically integrated components. The first function unit defines the electric properties of all the input and output interfaces of the entire processing unit. All essential connections of the second function unit are accessible from the outside only via the first function unit. For this purpose, the first function unit contains interface circuits that are used for electric matching of the connections of the second function unit to those of the external conditions.

One object of the present invention is to provide an expandable control unit for vehicle components, which is suitable for controlling minor data processing tasks and is adaptable to very complex data processing tasks by means of another circuit. The expansion circuit of the data processing capacity can be connected to the control unit as a standard module, resulting in a simple and moldularized expansion option for the control unit.

This and other objects and advantages are achieved by the expandable control unit according to the invention, which has an interface by which the circuit is connectable to the internal data bus. The circuit is encapsulated within a housing with a voltage supply, level converter, expansion memory, sensor/actuator interface and logic processing unit. The level converter is provided for adjusting the voltage level of the signals and/or data of the microcomputer to the voltage level of the circuit. The logic processing unit further processes data of the main memory means, and sensors and/or actuators can be connected directly to the circuit via the sensor/actuator interface. The circuit is designed as a multichip module within the housing, with the voltage supply, level converter and internal data bus of the circuit being provided on a basic chip connected to the housing. The processing unit and/or expansion memory are usable as separate chips in the circuit and/or exchangeable.

For engines with a higher number of cylinders, the present invention is based on the idea of connecting the additional modules (e.g., program memories in the form of read only memory (ROM), random access memory (RAM), flash memory (FLASH), magnetic random access memory (MRAM), Ferro Electronic random access memory (FRAM), etc., analog-digital converters (ADC), programmable logic such as field programmable gate array (FPGA), programmable array logical (PAL), generic array logic (GAL), programmable logic device (PLD), complex programmable logic device (CPLD), etc., level converters and voltage supply circuits) to form a multichip module. The programmable logic functions as a logic processing unit and is capable of performing tasks like a microcomputer. Algorithms such as sensor signal processing, filtering, engine characteristic map interpolation or Fourier transform may be performed in the logic processing unit. The parallel structures of the programmable logic are very fast, which makes possible the realtime capability of such control units. The logic processing unit of the expansion circuit also offers the possibility of simulating computer cores having different computation capacities and, for example, representing data processing operations in different processing widths such as 8-bit, 16-bit or 32-bit. The program code and the parameters for these computer cores are then available in the expansion memory of the circuit.

The multichip module contains a monolithically-integrated basic chip which includes the voltage supply, level converter and internal data bus of the circuit. Furthermore, buffer circuits and interface circuits may also be configurable so that the most up-to-date standards (e.g., Intel and Motorola standards), for the internal data bus can be met. The subcircuits in the expansion circuit of the data processing capacity can be addressed from the microcomputer via the address data bus. The circuit also has a serial interface via which the subcircuits of the circuit can also be addressed from the microcomputer, and is cascadable. (That is, multiple units can be addressed by one microcomputer.) The selection of the corresponding expansion circuit of the data processing capacity is made via special selector line such as a chip select line. Several circuits assigned to the control unit for expansion of the data processing capacity can be selected via the chip select line, so that a control function is performed. The circuit has a synchronization line to the microcomputer, so that it can be synchronized with the microcomputer of the control unit. However, there may also be a control based, for example, on the crank angle rotational speed of the internal combustion engine, which is synchronized with the crank angle. The expansion circuit can report events to the control unit over interrupt lines.

The level converters are used for adjusting the signal levels of the subcircuits of the expansion circuit designed as independent modules. Signal levels of a logic processing unit, memories or AD converters can be adjusted to the voltage level of the microcomputer. The level adjustment is necessary because each of the independent modules is designed with a technology that is optimum for its function, including the optimum voltage supply therefor. In the case of a programmable logic, for example, this may be a supply voltage of 1.2V; in the case of nonvolatile memories, a voltage supply of 3.3 V may be used and with AD converters a voltage supply of 5 V may be necessary. The level converters convert a wide variety of signal levels of the independent modules within the expansion circuit of the data processing capacity to a uniform signal level within the circuit. The level converters may be switched in the direction of internal address data bus and/or in the direction of the flash data memory in a tristate mode. (In the latter, different voltage levels may be provided depending on the direction of transmission.) The level converters have two voltage supplies. The signal level for the voltage supply to the individual chips (such as nonvolatile memory means, AD converters, monitoring unit, and programmable logic) is defined in particular via the voltage supply for the input circuit. At the output end, the level converters are connected to the supply voltage of the basic chip of the circuit. This configuration ensures adaptation of the signal level between the level converter and the microcontroller interface.

Because the signal levels may vary from one microcomputer to the next, even on the microcomputer side in the control unit, two supply voltages are provided for the basic chip of the expansion circuit. The first supply voltage is provided to the input and output stages of the address data bus or the serial interface to the microcontroller. This voltage supply is usually identical to the supply to the corresponding interfaces in the microcomputer. The basic chip itself is supplied with the second supply voltage. This means that here again the voltage signal level is adjusted through the supply voltage.

Each individual chip (e.g., each nonvolatile memory, AD converter, each monitoring unit, programmable logic and the microcontroller interface) receive an individual supply voltage. These supply voltages may either be supplied externally via the voltage pins or generated internally from the main supply for the expansion circuit. In the case of internal generation, the voltage regulators are adjustable, so that practically any conceivable supply voltage may be made available for the individual chips. The supply voltages may be in a range from 1 to 5 V. When using a switched-mode regulator or linear regulator, some of the components may be connected externally to the expansion circuit.

The expansion circuit may have a monitoring unit on the basic chip. The monitoring unit may be provided as an automatic state machine or as a small microcomputer which monitors individual program sequences.

The expansion memory and the logic processing unit may be manufactured in one embodiment according to a semiconductor technology that deviates from that of the basic chip. The resulting deviating voltage levels can then be adapted to the voltage level of the basic chip via the level converter. The logic processing unit of the circuit can preferably be used in sensor signal processing, in interpolation of an engine characteristics map or in a Fourier transform.

The expansion memory and the logic processing unit can be addressed by the microcomputer of the control unit via the address data bus, which may either be hardwired or implemented on the basic chip of the circuit via nonvolatile memories, a monitoring unit or the programmable logic. The functionality of the address data bus can be programmed flexibly by the user in the form of a bus unit or a bus bridge in the programmable logic.

For the configuration of RAM memory cells with a programmable logic arranged thereon (e.g., a field programmable gate array), the circuit may be provided as an independent chip. For configuration, a read only memory (ROM) may be present in the circuit so that the hardware description language or the configuration data can be loaded into the expansion memory of the circuit to configure the programmable logic of the logic processing unit.

The expansion circuit of the data processing capacity has nonvolatile memory means, AD converters, a monitoring unit and a programmable logic for processing the data. Each of these circuits may also be present in multiples. Three circuits within the expansion circuit are in the form of individual chips, for example, and are networked via a suitable housing and/or circuit module within the multichip module to form an integrated circuit. It is also possible to integrate multiple subcircuits monolithically in one chip.

The expansion circuit has the address data bus which is configurable by means of data of a memory means and which fulfills the conventional standards for address data buses. Subcircuits in the expansion circuit can be addressed directly by the microcomputer of the control unit via the address data bus. The expansion circuit has a serial interface over which the subcircuits can be addressed by the microcomputer.

The basic chip of the expansion circuit may also be designed as a chip on a ceramic carrier (e.g., LTCC), together with the expansion circuit. The connection between the individual chips and the periphery can be established via a bonding connection. The basic chip may also be implemented as a module on a circuit board together with a program memory expansion, an analog-digital converter unit and a monitoring unit. The connection between the individual modules and the periphery can be established via a printed conductor.

Other objects, advantages and novel features of the present invention will become apparent from the following detailed description of the invention when considered in conjunction with the accompanying drawings.

### BRIEF DESCRIPTION OF THE DRAWINGS

The single FIGURE shows a control unit according to the invention having two circuits for expansion of the data processing capacity.

### DETAILED DESCRIPTION OF THE DRAWINGS

Referring to the figure, the expandable control unit 1, provided as an engine or transmission control unit in a vehicle, has a microcomputer 2 with a main memory means 3 in the form of a random access memory (RAM) and a read only memory (ROM). Input/output interfaces 4, 5 are provided for connecting external sensors and/or actuators 6. Output stages 5 are provided for connecting the actuators. The microcomputer 2 has analog-digital converters (ADC) and a programmable interface (GPIO). The control unit 1 additionally has an interface for connecting an external vehicle data bus 12 to the control unit 1, so that it can be networked with other control units in the vehicle. For example, a controller area network (CAN) may be provided as the vehicle data bus 12. In addition to the CAN data bus 12, the control unit 1 has an internal data bus 7 and an internal control unit data bus 8 for exchanging data within the control unit with the various circuit parts. Multiple expansion circuits 9, 10 may be connected to the internal data bus 7 and the internal control unit data bus 8 of the control unit 1 via an interface 11 of the control unit 1.

The circuit 9 for expansion of the data processing capacity has a voltage supply 14 with an interface for connection to the control unit 1. In particular, the interface connects the internal control unit data bus 8 with the data bus 7 to the circuit 9. Then each subcircuit within the circuit 9 can be addressed by the microcomputer 2 via the address data bus 22 of the circuit 9. The circuit 9 has multiple level converters 15 through 18 which: convert the incoming signals from the control unit 1 based on their voltage level, so that a logic processing unit 21, an expansion memory 19 or the sensor-actuator interface 20 of the circuit 9 can be addressed by the microcomputer 2 of the control unit 1. The circuit 9 has internal data lines 23 for supplying the data transmitted from the microcomputer 2 to the circuit 9 to the logic processing unit 21 or to the expansion memory 19. The logic processing unit 21 processes the specified data by means of an algorithm, so that an actuator connected directly to the circuit 9 is controllable accordingly via a sensor-actuator interface 20. Another circuit 10 (constructed analogously to circuit 9) for expansion of the data processing capacity of the control unit 1 is provided in a separate housing. However, a different algorithm is installed in the logic processing unit 21 of the circuit 10 so that a different actuator can be controlled via the sensor-actuator interface 20 of the circuit 10 than with the circuit 9.

The expansion circuits 9 and 10 are designed as multichip modules so that different circuits can be placed on a basic chip and controlled there. The expansion circuits make it possible on the one hand to expand control units with a standard module, thus permitting scalability, i.e., a higher computation capacity in accordance with the data processing without requiring an additional control unit. On the other hand, electric circuits can also be simulated with the circuits 9 and 10, so that an electronic unit can be simulated as a replacement part in older vehicles despite the fact that the microcomputer 2 is no longer supplied by the industry.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An expandable control unit for controlling components in a vehicle, having a microcomputer with a main memory unit and input/output interfaces for connecting at least one of external sensors and actuators, an internal data bus in the microcomputer for transfer of at least one of addresses and data and for networking with additional control units, an external vehicle data bus in the microcomputer, and a circuit for expanding the data processing capacity of the microcomputer; wherein:
the microcomputer has an interface by which the circuit can be connected to the internal data bus;
the circuit is provided within the control unit on a circuit board having a voltage supply, level converters, expansion memory, sensor/actuator interface and a logic processing unit;
the level converters are provided for adjusting the voltage level of the signals and/or data of the different components of the circuit;
the logic processing unit further processes data coming from the microcomputer;
at least one of sensors and actuators can be connected directly to the circuit via the sensor/actuator interface;
the circuit is designed as a multichip module, with the voltage supply and interfaces to the microcomputer of the circuit provided as a monolith on a basic chip connected to the housing; and
at least one of the logic processing unit and the expansion memory is usable or exchangeable as separate chips in the circuit.

2. The control unit as claimed in claim 1, wherein:
the expansion memory and the logic processing unit are manufactured according to a semiconductor technology which is different from that of the basic chip; and
the expansion memory and the logic processing unit have voltage levels that differ from those of the basic chip, and can be adapted to the voltage level of the basic chip by the level converters.

3. The control unit as claimed in claim 1, wherein the control unit is an engine/transmission control unit.

4. The control unit as claimed in claim 3, wherein the logic processing unit performs one of sensor signal processing, interpolation of an engine characteristics map and Fourier transformation.

5. The control unit as claimed in claim 4, wherein the logic processing unit is a programmable logic circuit which can be programmed by downloading a hardware programming language.

6. The control unit as claimed in claim 1, wherein the expansion memory and the logic processing unit are addressable by the microcomputer of the control unit via the address data bus of the circuit.

7. The control unit as claimed in claim 6, wherein communication channels of the module of the circuit are flexibly programmable via the programmable logic circuit.

8. The control unit as claimed in claim 7, wherein the programmable logic circuit has a direct connection from the expansion memory to the basic chip, by which the expansion memory is programmable directly by the microcomputer.

9. The control unit as claimed in claim 1, wherein:
a multiplicity of circuits is present; and
a choice of a corresponding circuit is made via special selector circuits which are controlled by the microcomputer.
